(19) United States
(12) Patent Application Publication
(10) Pub. No.: US 2007/0143170 A1
(43) Pub. Date: Jun. 21, 2007

(54) Materials including coded writing

(75) Inventors: Nathan Proch, Los Angeles, CA (US); Bryan Benedict, Torrance, CA (US); Wayne Scott, Playa Del Rey, CA (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: Mattel, Inc.

(21) Appl. No.: 11/303,821

(22) Filed: Dec. 16, 2005

(51) Int. Cl. G06F 17/30

(52) U.S. Cl. 705/10

(57) ABSTRACT

A system and method of using a coded language to market assets, including goods and/or services. A first asset can be offered with materials that are at least partially written in an uncoded language. A second asset, that is related to the first asset, can be offered with materials that are at least partially written in a coded language. Common words can be used on the materials corresponding to the first asset and the materials corresponding to the related second asset. The common words on the materials corresponding to the first asset can be written in the uncoded language, while the common words on the materials corresponding to the related second asset can be written in the coded language. The uncoded words can be used to decipher the coded words, as well as other words written in the same coded language.

### CROSS REFERENCE TO RELATED APPLICATIONS

This application is related to U.S. Application No. ______, for PROGRESSIVE PUZZLE, filed Dec. 16, 2005, by Nathan Proch, Bryan Benedict, and Wayne Scott, the entirety of which is hereby incorporated herein by reference for all purposes.

### BACKGROUND

The marketing of goods and services can be critically important to the success of those goods and services. Various marketing systems exist, including radio, television, and internet advertising. One particularly effective method of marketing goods and services includes presenting the goods and services to the public with written materials that are designed in a visually interesting manner, so as to attract the attention of consumers. Furthermore, written materials offered with goods and services can include content that is desired by consumers, thus creating a motivation for consumers to purchase the goods and services.

### SUMMARY

A system and method of using a coded language to market assets, including goods and/or services, is provided. A first asset can be offered with materials that are at least partially written in an uncoded language. A second asset, that is related to the first asset, can be offered with materials that are at least partially written in a coded language. Common words can be used on the materials corresponding to the first asset and the materials corresponding to the related second asset. The common words on the materials corresponding to the first asset can be written in the uncoded language, while the common words on the materials corresponding to the related second asset can be written in the coded language. The uncoded words can be used to decipher the coded words, as well as other words written in the same coded language.

### BRIEF DESCRIPTION OF THE DRAWINGS

FIG. 1 shows a toy car package including uncoded writing.

FIG. 2 shows a toy car package including coded writing.

FIG. 3 shows an exemplary coded alphabet and a corresponding reference alphabet.

### WRITTEN DESCRIPTION

Written materials can be used to facilitate the sale of various goods and services. Such written materials can be designed to attract and hold the attention of consumers, thereby increasing the likelihood that a consumer will purchase the goods or services corresponding to the written materials. Written materials can also enhance a consumer's satisfaction after a sale is made. Among other features, the present disclosure is directed to a novel marketing concept for attracting and holding the attention of consumers and/or enhancing post-sale consumer satisfaction.

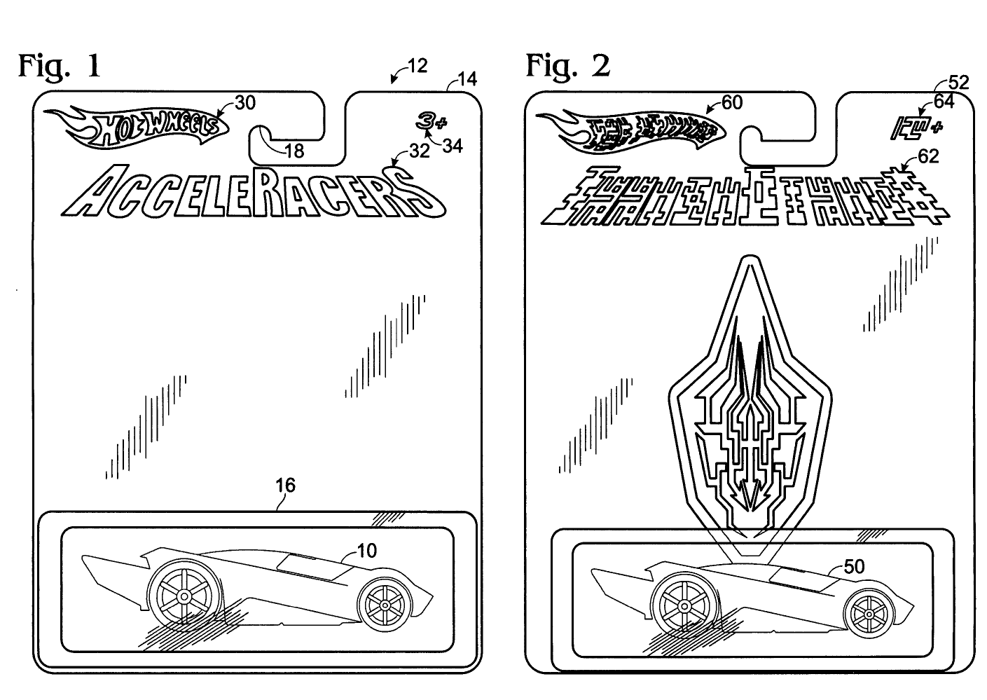

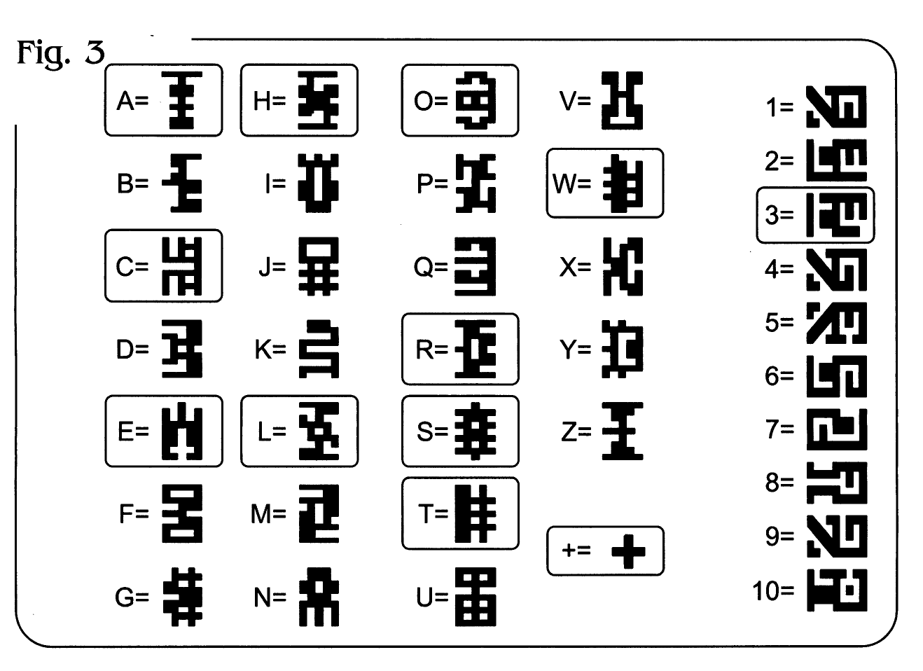

FIGS. 1 and 2 show exemplary toy car packaging that can be used to attract and hold the attention of consumers. While the present disclosure is presented with reference to written materials in the form of product packaging, it should be understood that virtually any other written material can be used. Furthermore, though described below in the context of a toy car, written materials according to the present disclosure can be used with virtually any goods or services. As used herein, the term “asset” is used to generically describe all goods and services, and “written materials” is intended to describe virtually any item with one or more words written thereon, including, but not limited to, packaging, instruction manuals, information flyers, advertising, and the like.

FIG. 1 shows a toy car 10 packaged in a holder 12 that is configured to display the toy car. Holder 12 is a blister pack that includes a cardboard backing 14 to which a clear plastic container 16 is affixed. The toy car is positioned between the cardboard backing and the clear plastic container. The cardboard backing includes a hanger 18, which is designed to allow holder 12 to hang from a rack in a store. When presented in this manner, consumers can easily examine holder 12 and toy car 10. Of course, numerous different types of holders (i.e., packaging) can be used to display different goods and/or to display goods in a different manner. Furthermore, written materials can be associated with services, and presented to consumers when such services are advertised, sold, and/or performed.

Holder 12 includes several “words” that are used to attract consumer attention and convey information about the contents of the holder. For example, at 30, the word HOTWHEELS is written; at 32, the word ACCELERACERS is written; and at 34, the word 3+ is written. The words are not coded or otherwise presented in a manner that prevents a consumer from easily reading the package. As used herein, the term “uncoded” is used to describe such writing. In the illustrated example, each of the uncoded words are written in the English language, although this is not required. It should be understood that the illustrated words present nonlimiting examples of the many different ways that writing can be used on a packaging, or other written material. Writing can be used to signal the source of origin for the goods, provide information about the type of consumer for which the goods are designed, provide information about the goods, provide information about related goods, etc.

FIG. 2 shows a toy car 50 similar to toy car 10 of FIG. 1. Toy car 50 is packaged in a holder 52 that is configured to display toy car 50 in much the same way as holder 12 is configured to display toy car 10. Holder 52 is approximately the same size and shape as holder 12, although this is not required. Like holder 12, holder 52 includes several words that are used to attract consumer attention. However, unlike holder 12, the words on holder 52 are written in a coded language that does not have a readily apparent meaning.

Because consumers are not accustomed to packages that include words that are written in a coded language, such a package presents a unique, visually interesting, method of presenting a product for sale. In particular, such a package is particularly suited for catching the eye of a consumer, which can lead to a close inspection of the package and its contents. This can be enhanced when a package including coded writing is displayed side-by-side with a package that includes uncoded writing, especially if other aspects of the coded and uncoded packages (e.g., size, shape, colors, graphics, etc.) are similarly designed. While a side-by-side comparison may enhance the effect, it is not necessarily required that coded and uncoded written materials be displayed side-by-side.

Like package 12, package 52 includes three words, which are respectively illustrated at 60, 62, and 64. Although these words are written in a coded language, they are the same words that are written in the uncoded language on holder 12. Word 60 is HOTWHEELS, word 62 is ACCELERACERS, and word 64 is 3+. This is not readily apparent, because the coded language uses a coded alphabet with “letters” that are not well known. However, based on the size, shape, graphics, kerning, italicization, and other visual aspects of the way the coded words are presented, it is clear that the same information is being conveyed when the packages are compared side-by-side.

For example, on both packages, the word HOTWHEELS is presented in a flame graphic with the letters of the word curving to match the shape of the flame graphic. Furthermore, on both packages, HOTWHEELS is written in the same size and at the upper left hand corner.

As another example, on both packages, the word ACCELERACERS is presented so that letters on the left hand side of the package are italicized so that they lean from left to right, with letters farther on the left side of the package being more italicized than letters near the center of the package. The letters on the right side are italicized so that they lean from right to left, with the letters farthest to the right having the greatest degree of italicization. The first letter “A,” the seventh letter “R”, and the twelfth letter “S” of ACCELERACERS is written in the same enlarged size on both packages, while the other letters are written in the same reduced size on both packages. The word is positioned so that it spans nearly the entire width of the package, just below the hanger, on both packages.

As a final example, the word 3+ is italicized and positioned in the same size at the upper right hand corner of both packages. These are nonlimiting examples of how uncoded and coded versions of the same word can be presented in the same manner on different packages. The similarities in how the words are presented on the different packages helps establish a natural connection between the words, which can serve as a clue that the coded language version of the word is not nonsensical, but rather a coded version that can be deciphered.

The coded language which is used to write words 60, 62, and 64 is designed such that every letter from the English language alphabet, which in this case serves as a reference language alphabet, has a corresponding symbol in the coded language. In other words, the coded language is designed so that every letter of an uncoded reference language, such as English, has a corresponding coded letter. Holder 12 can serve as a Rosetta Stone for deciphering the coded language. While English is used as an exemplary uncoded language, it should be understood that other languages can additionally or alternatively serve as a reference uncoded language, to which a coded language can correspond. Furthermore, in some embodiments, there may not be a one-to-one correspondence between coded and uncoded letters.

Both packages include the words: ACCELERACERS, HOTWHEELS, and 3+. Holder 12 includes uncoded language versions of these words while holder 52 includes coded language versions of these words. By comparing the two packages to one another, the coded language equivalent of the following letters can be deciphered: a, c, e, h, l, o, r, s, t, w, 3, and +. These are the letters that are used to spell the words ACCELERACERS, HOTWHEELS, and 3+. Other portions of the packages (not shown), or materials that come with the packages (not shown), or are otherwise associated with the toy cars, may be used to decode other letters. A coded language package and an uncoded language package, and/or other coded and uncoded written materials, can include enough words, spelled with enough different letters, so that an entire coded language alphabet can be deciphered. Once deciphered, any coded language words can be read, even if an uncoded language equivalent of the particular words is not available for comparison.

FIG. 3 shows the coded language used to write words 60, 62, and 64. FIG. 3 also shows the letter from the reference alphabet that corresponds to each letter in the coded alphabet. The letters used to write words 60, 62, and 64 are circled. In the illustrated embodiment, coded and uncoded materials other than holders 12 and 52 are needed to decipher the letters that are not circled. Other coded alphabets can be used, included coded alphabets with more or fewer letters.

A coded language that is associated with a particular asset or group of assets (goods and/or services), can add a depth to the asset, and thereby increase its desirability. Deciphering the code can prove challenging, thus rewarding a consumer with a sense of satisfaction once the code is deciphered. Furthermore, the code may be used in contests and/or promotions, in which it may be beneficial to know how to read the coded language. As a nonlimiting example, a coded word on materials corresponding to a particular product may include a key for unlocking a special feature of that product, such as a hidden level in a video game, or a hidden website associated with the product. The coded word can be presented so that there is no corresponding uncoded word on different written materials, so that the only way to read the coded word is to decipher the coded language (using other available materials, such as packages 12 and 52). This is a nonlimiting example of how coded words can be used to increase a consumer's interest in an asset.

Written materials can be provided in coded and uncoded versions for products that are related in some manner. For example, coded and uncoded versions of written materials may be provided for the same asset, different assets in the same line of assets, different assets offered from the same source, etc. In some embodiments, the coded language version of written materials may not have a corresponding uncoded language version, and decoding must be achieved via a different mechanism. In some embodiments, the coded language may be undecipherable.

The present disclosure has been provided with reference to a nonlimiting subset of the various embodiments and operational principles defined by the appended claims. It will be apparent to those skilled in the art that various changes in form and detail may be made without departing from the spirit and scope of the disclosure. Accordingly, the claims should not be interpreted as being limited to the particular embodiments disclosed herein, but rather, should be afforded a full breadth that embraces all alternatives, modifications, and variances allowed by the plain meaning of the claims. Where the disclosure or claims recite “a,” “a first,” or “another” element, or the equivalent thereof, they should be interpreted to include one or more such elements, neither requiring nor excluding two or more such elements.

1. A method of marketing with a coded language, comprising:
offering a first asset with materials at least partially written in an uncoded language; and
offering a related second asset with materials at least partially written in a coded language;
where the materials with the first asset and the materials with the related second asset use common words, the common words being written in the uncoded language for the first asset and in the coded language for the second asset.

2. The method of claim 1, where an uncoded version of at least one common word is presented substantially the same on the materials with the first asset as a coded version of that common word is presented on the materials with the related second asset.

3. The method of claim 2, where the common word is presented in substantially similar sizes on the materials with the first asset and the materials with the related second asset.

4. The method of claim 2, where the common word is presented with substantially similar formatting on the materials with the first asset and the materials with the related second asset.

5. The method of claim 2, where the materials with the first asset and the materials with the related second asset are sized and shaped substantially similarly, and where the common word is presented in substantially similar positions on the materials with the first asset and the materials with the related second asset.

6. The method of claim 1, where the materials with the first asset and the materials with the related second asset are collectively configured to facilitate decoding the coded language.

7. The method of claim 1, further comprising displaying the first asset with writing in the uncoded language side-by-side with the second asset with writing in the coded language.

8. A package, comprising:
a product; and
a holder for displaying the product including coded words written in the same manner as those words are written uncoded on related holders that are configured to display related products.

9. The package of claim 8, where the coded words are written in substantially the same size as those words are written uncoded on the related holders that are configured to display the related products.

10. The package of claim 8, where the coded words are written in substantially the same format as those words are written uncoded on the related holders that are configured to display the related products.

11. The package of claim 8, where the coded words are written at substantially the same location on the holder as those words are written uncoded on the related holders that are configured to display the related products.

12. A marketing system, comprising:
a first package including an uncoded version of at least one word; and
a related second package including a coded version of the at least one word.

13. The marketing system of claim 12, where the uncoded version of the at least one word is presented on the first package substantially the same as the coded version of the at least one word is presented on the related second package.

14. The marketing system of claim 13, where the uncoded version of the at least one word and the coded version of the at least one word are presented in substantially similar sizes.

15. The marketing system of claim 13, where the uncoded version of the at least one word and the coded version of the at least one word are presented with substantially similar formatting.

16. The marketing system of claim 13, where the uncoded version of the at least one word and the coded version of the at least one word are presented at substantially similar locations on the first package and the second package.

17. The marketing system of claim 12, where the first package includes an uncoded version of a plurality of different words, and where the related second package includes a coded version of each of the plurality of different words.

18. The marketing system of claim 17, where the uncoded version of each of the plurality of different words is presented on the first package substantially the same as the coded version of that word is presented on the related second package.

19. The marketing system of claim 12, where the first package and the related second package are collectively configured to facilitate decoding a coded alphabet used to present the at least one word on the second package.

20. The marketing system of claim 12, where the related second package includes substantially only coded words.
